(19) United States
(12) Patent Application Publication
(10) Pub. No.: US 2004/0062413 A1
(43) Pub. Date: Apr. 1, 2004

(54) Wireless ear-piece interchangeable microphone/antenna tubes

(76) Inventor: Shary Nassimi, Ridgefield, WA (US)

Correspondence Address: The Law Office of Craig W. Barber, PO Box 16220, Golden, CO, 80402-6004, US

(21) Appl. No.: 10/443,203

(22) Filed: May 22, 2003

Related U.S. Application Data
(63) Continuation-in-part of application No. 10/261,367, filed on Sep. 30, 2002.

(51) Int. Cl. H04R 25/00

(52) U.S. Cl. 381/380

(57) ABSTRACT

The present invention teaches a wireless ear-piece such as may be used in conjunction with a base unit attached to an office telephone, cell telephone, etc. The ear-piece is of a compact body construction which sits at the user's ear, supported by the physical engagement of an ear tube with the inner surface of the ear canal of the user. The unit's microphone sits at the user's ear, within the body. In order to allow adjustment of the device per ambient auditory conditions, a number of interchangeable microphone tubes may be applied so as to more clearly transmit the voice of the user to the microphone. The microphone tubes may also be rotated so as to allow adjustment of beveled microphone tube ends. The microphone tube beveled end further features a grill work across the opening. The microphone tubes may also function as interchangeable radio antennas for the wireless ear-piece.

### CROSS-REFERENCE TO RELATED APPLICATION

This application is a CIP (Continuation-in-Part) of U.S. patent application Ser. No. 10/261,367 filed Sep. 30, 2002 and entitled ADJUSTABLE EAR CANAL RETENTION TRANSCEIVER/RECEIVER, to the same inventor, Shary Nassimi.

### FIELD OF THE INVENTION

This invention relates generally to wireless headsets and specifically to an ear-piece headset having a microphone located at the body of the headset and a microphone tube extending from the body of the headset towards the mouth of the user.

### BACKGROUND OF THE INVENTION

Telephones are becoming smaller from year to year, thus offering users increased convenience. Wireless headsets add convenience and safety for the users of such devices as office telephones and cellular phones, by allowing the user partially or completely hands free operation of the cell phone. This is of particular importance during office work because the increase in efficiency of staffers who are called to the telephone is dramatic. This is also important during operation of motor vehicles, athletic activities and similar times during which users require the use of two hands for other activities. Such headsets normally comprise some sort of head band or ear clip to retain the headset in the proper position, a microphone located near the mouth, and such wireless equipment as is necessary to communicate with a base unit located at or on the cell phone or similar device. (Note that there are also “wired” headsets which do not have the advantages of wireless connection between the base unit—attached to the cellular telephone or office telephone—and the headset portion.)

Wireless headsets may now be reduced in size to an earpiece, in which the comfort and sanitation of the user and the life span of the device may in increased by providing a replaceable compliant polymer sheath for the sound tube which is inserted into the ear canal: friction between the ear canal and the sheath retains the wireless ear-piece headset in the ear canal. In alternative embodiments, the sheath and ear canal may mechanically cooperate to retain the wireless ear-piece headset in the ear canal. The sheath may be easily removed and replaced so as to adapt the length and diameter of the device for the needs and comfort of different users. Just such an invention is the subject matter of co-pending and parent U.S. patent application Ser. No. 10/261,367 filed Sep. 30, 2002 and entitled ADJUSTABLE EAR CANAL RETENTION TRANSCEIVER/RECEIVER, to the same inventor, Shary Nassimi.

Co-pending U.S. patent application Ser. No. 10/335,544 filed Oct. 30, 2003 and entitled WIRELESS EAR-PIECE WITH CONDUCTIVE CASE, to the same inventor, Shary Nassimi, teaches that such an ear-piece may have a conductive case, in order to provide capacitive coupling of the device with the body of the user, thus providing improved reception.

The disadvantage of ear-piece style units is that the microphone is necessarily located at the ear-piece and is thus not in immediate proximity to the user's mouth. Various types of microphone tubes have been proposed in an attempt to deal with this problem. Long microphone tubes may extend to the user's mouth, but may not fit all users, depending upon head size. Short microphone tubes, or no microphone tubes, may be used by any user, but then environmental considerations come into play. In particular, environmental noises such as office work, traffic sounds and so on may impinge, thus degrading the quality of the reception. Yet for reasons of compactness, it is desirable to avoid a long boom.

U.S. Pat. No. 6,496,589 issued Dec. 17, 2002 to Pham et al for teaches one extremely common type of head set device which is not an ear-piece, and in addition positions the microphone at the mouth of the user. Positioning the microphone at the mouth of the user inherently teaches away from positioning of the microphone at the ear of the user and further teaches away from the use of any microphone sound tube at all.

U.S. Pat. No. 6,477,258 issued Nov. 5, 2002 to Watson et al for TRANSDUCER ASSEMBLY teaches use of a sound tube running to the ear from an electronic microphone located near the mouth of the user. This device concerns a plug-in or “wired” headset and thus is not from the same art as the present invention.

U.S. Pat. No. 6,396,935 issued May 28, 2002 to Makkonen for HEADSET AND METHOD FOR A HEADSET teaches a long boom which is deformable and has a microphone located in the extreme end closest to the user's mouth. No replaceable parts are suggested.

U.S. Pat. No. 6,377,697 issued Apr. 23, 2002 to Cheng for EAR-MOUNTED HEADSET DEVICE teaches a complex and adjustable ear-piece which, like the '935 patent, is adjustable to the individual user. However, no user replaceable parts are suggested.

U.S. Pat. No. 6,233,344 issued May 15, 2001 to Clegg et al for EAR-HOOK BOOM MICROPHONE and U.S. Pat. No. 6,490,362 issued Dec. 3, 2002 to the same inventor for EXTERNAL EAR SPEAKER EAR-HOOK BOOM MICROPHONE both teach a design having the microphone located near the mouth of the user and do not teach any microphone sound boom.

U.S. Pat. No. 5,581,622 issued Dec. 3, 1996 to Sakurai for HEAD SET teaches yet another design having an microphone extended towards the user's mouth and thus does not teach any microphone boom.

U.S. Pat. No. 4,617,431 issued Oct. 14, 1986 to Scott et al for VOICE TUBE ASSEMBLIES FOR POST-AURICLE HEADSETS teaches another adjustable microphone boom similar to the '935 patent in concept but implemented by means of an internal shaping wire in a thin boom.

U.S. Pat. No. 4,588,867 issued May 13, 1986 to Konomi for EAR MICROPHONE teaches methods for an ear-piece having a microphone but no microphone tube extending towards the mouth of the user.

It would be advantageous to provide an ear-piece which is both of a compact and convenient size and shape, yet which allows adjustment of a microphone tube or tubes in order to allow for ambient sound conditions. It would further be advantageous to provide an ear-piece in which radio antennas may be interchanged by the user in order to allow for ambient radio transmission conditions.

### SUMMARY OF THE INVENTION

General Summary

The present invention teaches a wireless ear-piece such as may be used in conjunction with a base unit attached to an office telephone, cell telephone, etc. The ear-piece is of a compact body construction which sits at the user's ear, supported by the physical engagement of an ear tube with the inner surface of the ear canal of the user. The unit's microphone sits at the user's ear, within the body. In order to allow adjustment of the device per ambient auditory conditions, a number of interchangeable microphone tubes may be applied so as to more clearly transmit the voice of the user to the microphone. The microphone tubes may also be rotated so as to allow adjustment of beveled microphone tube ends. The microphone tube beveled end further features a grill work across the opening. The microphone tubes may also function as interchangeable radio antennas for the wireless ear-piece.

Summary in Reference to Claims

It is therefore a first advantage, aspect, objective and embodiment of the present invention to provide a wireless ear-piece headset for use with a plurality of user interchangeable microphone tubes, the ear-piece comprising: an ear tube dimensioned and configured to be inserted into a human ear and to physically engage with the inside of the ear canal, a body from which the ear tube projects, the body being light enough to be supported by the physical engagement of the body and ear canal, the body being a substantially compact body located at the ear of the user, a microphone located in the body, whereby the microphone is located at the ear, a retainer located at the microphone, the retainer dimensioned and configured to physically engage with one such user interchangeable microphone tube.

It is therefore yet another advantage, aspect, objective and embodiment of the present invention to provide an ear-piece, wherein such microphone tubes have an end hole which fits over the retainer, and the end hole has a retainer race, and the retainer has a ridge which seats into the retainer race, whereby the physical engagement of the microphone tube and the body is attained.

It is therefore yet another advantage, aspect, objective and embodiment of the present invention to provide an ear-piece wherein such microphone tubes have an end hole which fits over the retainer, and the end hole is internally threaded, and the retainer is externally threaded, whereby the physical engagement of the microphone tube and the body is attained.

It is therefore yet another advantage, aspect, objective and embodiment of the present invention to provide a wireless ear-piece headset comprising: an ear tube dimensioned and configured to be inserted into a human ear and to physically engage with the inside of the ear canal, a body from which the ear tube projects, the body being light enough to be supported by the physical engagement of the body and ear canal, the body being a substantially compact body located at the ear of the user, a microphone located in the body, whereby the microphone is located at the ear, a retainer located at the microphone, and a plurality of rigid microphone tubes, each microphone tube dimensioned and configured to physically engage with the retainer.

It is therefore yet another advantage, aspect, objective and embodiment of the present invention to provide an ear-piece, wherein the microphone tubes may rotate when physically engaged with the retainer.

It is therefore yet another advantage, aspect, objective and embodiment of the present invention to provide an ear-piece, wherein the microphone tubes have an open end which is beveled at an angle to the longitudinal axis of the microphone tubes.

It is therefore yet another advantage, aspect, objective and embodiment of the present invention to provide an ear-piece, wherein the microphone tubes have an open end and have a grill across the open end.

It is therefore yet another advantage, aspect, objective and embodiment of the present invention to provide an ear-piece, wherein the microphone tubes each further comprise an antenna.

It is therefore yet another advantage, aspect, objective and embodiment of the present invention to provide an ear-piece wherein the antenna is located in the interior of the microphone tube.

It is therefore yet another advantage, aspect, objective and embodiment of the present invention to provide an ear-piece, wherein the antenna is located in the microphone tube wall.

It is therefore yet another advantage, aspect, objective and embodiment of the present invention to provide an ear-piece, wherein the microphone tubes comprise a conductive material, whereby the antenna comprises the conductive material of the microphone tube.

It is therefore yet another advantage, aspect, objective and embodiment of the present invention to provide a wireless ear-piece headset for use with a plurality of user interchangeable antennas, the ear-piece comprising: an ear tube dimensioned and configured to be inserted into a human ear and to physically engage with the inside of the ear canal, a body from which the ear tube projects, the body being light enough to be supported by the physical engagement of the body and ear canal, the body being a substantially compact body located at the ear of the user, a microphone located in the body, whereby the microphone is located at the ear, a retainer, the retainer dimensioned and configured to physically engage with one such user interchangeable antenna.

It is therefore yet another advantage, aspect, objective and embodiment of the present invention to provide an ear-piece wherein such antennas have an end hole which fits over the retainer, and the end hole has a retainer race, and the retainer has a ridge which seats into the retainer race, whereby the physical engagement of the antenna and the body is attained.

It is therefore yet another advantage, aspect, objective and embodiment of the present invention to provide an ear-piece wherein such antennas have an end hole which fits over the retainer, and the end hole is internally threaded, and the retainer is externally threaded, whereby the physical engagement of the antenna and the body is attained.

### BRIEF DESCRIPTION OF THE DRAWINGS

FIG. 1 is an oblique bottom view of an ear-piece body according to a first embodiment of the invention.

FIG. 2 is an oblique top view of the ear-piece body according to the first embodiment of the invention.

FIG. 3 is a top oblique view of a microphone tube according to a second embodiment of the invention.

FIG. 4 is a bottom oblique view of a microphone tube according to the second embodiment of the invention.

FIG. 5 is a bottom oblique view of a microphone tube according to a third embodiment of the invention.

FIG. 6 is a top oblique view of a microphone tube according to the third embodiment of the invention.

FIG. 7 is a bottom view of the invention according to a fourth embodiment of the invention assembled with the microphone tube on the device.

### INDEX TO DIAGRAMS

| | |
|---|---|
| 100 | Ear-Piece Body, bottom half |
| 102 | Case, bottom half |
| 104 | Ear tube |
| 106 | Microphone housing |
| 108 | Retainer |
| 110 | Ridge |
| 200 | Microphone Tube |
| 202 | Boom |
| 204 | Base |
| 206 | Base hole to interior |
| 208 | Base end |
| 210 | Retainer race |
| 212 | Beveled end |
| 214 | Beveled end hole to interior |
| 216 | Grill |
| 300 | Microphone Tube |
| 304 | Base |
| 306 | Base hole to interior |
| 308 | Base end |
| 310 | Retainer race |
| 312 | Beveled end |
| 314 | Beveled end hole to interior |
| 316 | Grill |
| 400 | Ear-piece and microphone tube |
| 402 | Case |
| 412 | Microphone tube |
| 416 | Open end |

### DETAILED DESCRIPTION

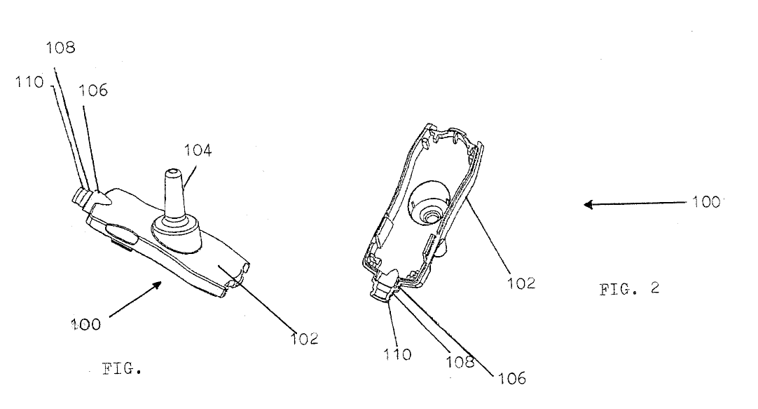

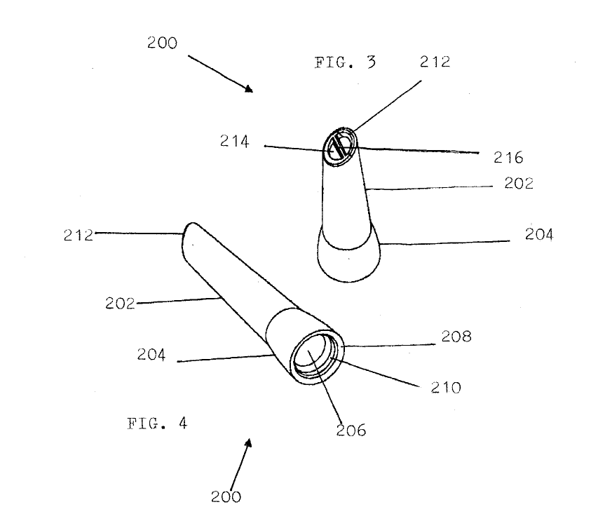

FIG. 1 is an oblique bottom view of an ear-piece body according to a first embodiment of the invention. FIG. 2 is an oblique top view of the ear-piece body according to the first embodiment of the invention. In the presently preferred embodiment and best mode presently contemplated for carrying out the invention, ear-piece body 100 (the bottom half) comprises case bottom 102, from which ear tube 104 projects, the entire body, including internal equipment such as battery, electronics, speaker and microphone being light enough to be supported by the physical engagement of the ear tube 104 and the ear canal of the user. Body 100 is a substantially compact body located at the ear, and thus maintaining the various parts of the device (except microphone tubes/antennas of some length) in a position also close to the ear.

Ear tube 104 is dimensioned and configured to be inserted into a human ear and to physically engage with the inside of the ear canal. As depicted in the first embodiment, the ear tube may be a cylindrical or conical shape, but it may also be molded to fit the shape of the ear canal, or another shape. The physical engagement may be simple friction or may be (in more complex molded shapes) designed to actually “lock” into the ear canal's internal shape.

A microphone (not depicted) is located in the body 100, inside of microphone housing 106, whereby the microphone is located at the ear of the user.

Retainer 108 projects from body 100 (in the preferred embodiment shown, from the microphone housing 106). The retainer 108 is dimensioned and configured to physically engage with user interchangeable microphone tubes as will be disclosed below in reference to FIGS. 3 to 6. Note that the three embodiments of FIGS. 1 through 6 comprise a single meta-embodiment such as may be sold as a single commercial unit, with the three embodiments sold together or with the intent to be used together.

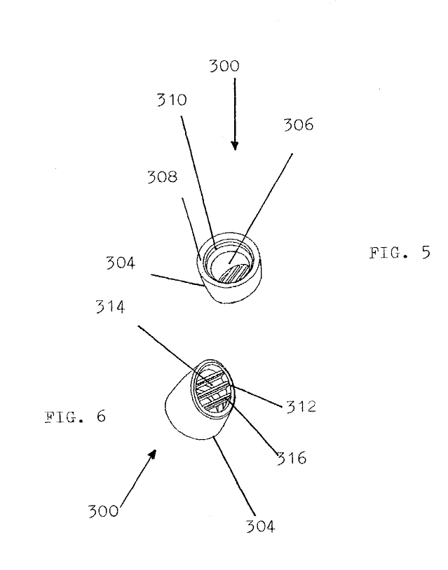

FIG. 3 is a top oblique view of a microphone tube/antenna 200 according to a second embodiment of the invention. FIG. 4 is a bottom oblique view of microphone tube 200 according to the second embodiment of the invention. Tube 200 comprises boom 202, base 204, base hole 206, base end 208, retainer race 210, beveled end 212, beveled end hole 214, and grill 216. FIG. 5 is a bottom oblique view of a microphone tube/antenna 300 according to a third embodiment of the invention. FIG. 6 is a top oblique view of microphone tube 300 according to the third embodiment of the invention. Tube 300 is shorter than tube 200 (in this embodiment, it entirely lacks any boom portion) but comprises base 304, base hole 306, base end 308, retainer race 310, beveled end 312, beveled end hole 314 and grill 316.

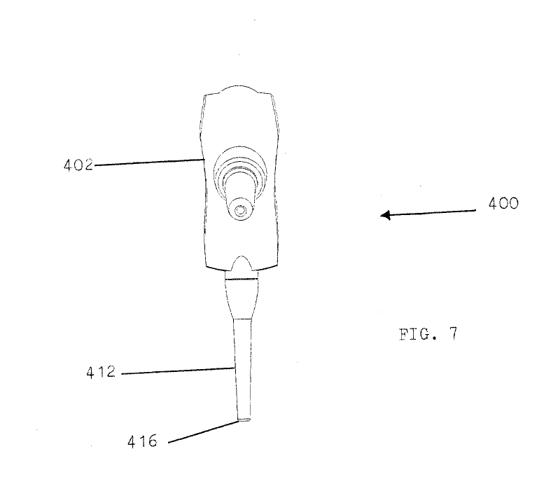

FIG. 7 is a bottom view of the ear-piece of the invention, with the microphone tube/antenna of the invention attached. Ear-piece 402 has microphone tube 412 attached. Microphone 412 has open end 416, which is not beveled, unlike microphone tubes 200/300.

Microphone tubes 200/300/412 are dimensioned and configured to attach to body 100. In particular, bases 204/304 are dimensioned and configured to engage with retainer 108. Physical engagement is used in the preferred embodiment. In more particularity, in the preferred embodiment, the microphone tubes are designed to “snap” to body 100. Base hole to interior 206 accepts retainer 108. The interior diameter of base hole 206 is very slightly smaller than the exterior diameter of retainer 108 at ridge 110, a toroidal projection from retainer 108. Exertion of modest force by the user causes ridge 110 to enter base hole 206 and seat securely into retainer race 210. At that point, base end 208 may be flush and adjacent to microphone housing 106. In the preferred embodiment, the physical engagement of body 100 to tube 200 or 300 is loose enough to allow rotation of tube 200/300 about it's own longitudinal axis. Note that microphone tube 412 may also be rotated in this embodiment, but such rotation serves no purpose as open end 416 is not beveled.

In alternative embodiments, other forms of engagement may be used. For example, non-physical engagement may be used: magnetic, adhesive, etc. Other types of physical engagement may be used: frictional engagement, snaps, latches, detents, bumps, clips, pins and combinations thereof.

In one partially favored alternative embodiment, retainer races 210/310 and retainer ridge 110 may be replaced by threading. By this means, tubes 200/300 may be screwed onto and unscrewed from body 100.

The hollow interior of microphone tubes 200/300 aids in sound conduction. The microphone (not pictured) within microphone housing 106 is effectively shielded from ambient noises such as office noise, traffic noise and so on, while sound (such as the voice of the user) which impinges into the beveled end of tube 200/300 is transmitted up the interior to microphone housing 106 and the housing within. However, it will be appreciated that by allowing the user to adapt to ambient conditions by removing one tube and using the ear-piece with no tube or a tube of different length, the user may adjust the relative degree of filtering or sensitivity of the invention.

For example, if the ear-piece of the invention is used with no microphone tube on microphone housing 106, sounds from a variety of sources may enter and be picked up by the microphone within body 100. (Note that microphone housing 106 may be omitted in alternative embodiments, while microphone housing 106 may extend from body 100 in other embodiments). On the other hand, by means of microphone tube 300 a modest degree of sound reduction may be achieved. In addition, a modest degree of microphone directionality may be achieved, in which sounds generally originating from the mouth area of the user are favored for pickup over sounds from different directions. Should microphone tube 300 be replaced by microphone tube 200 in the course of user selection and adjustment to conditions, the degree of directionality and the bias towards sound pickup from the user's mouth is greatly enhanced.

Obviously, such microphone tubes may have booms of various lengths, bases of various lengths, various diameters, cross sections and so on. In the preferred embodiments, the microphone tubes are rigid, but may be flexible in less preferred embodiments.

Beveled ends 212/312 have not yet been discussed in detail. It will be understood that beveled ends 212/312 increase the degree of directionality which the microphone tube allows. Rotation of the microphone tubes 212/312 alters the direction in which sound is preferentially admitted to the hollow interior of the microphone tube and thus transmitted to the microphone/body 100.

When beveled end 212/312 is rotated about the axis of the microphone tube 200 towards the mouth of the user, sounds from the user's mouth may be preferentially admitted and transmitted. On the other hand, if beveled end 212/312 is rotated away, the result is a relative bias against sounds from the user's mouth.

The angle of beveled end 212/312 may relatively slight, or may be omitted (as in open end 412), or the angle may be relatively great, such as ninety degrees or more. Beveled end hole 214/314 may also be positioned on one side of microphone tube 200/300.

Grill 216/316 which spans beveled end hole 214/314 is further of assistance in selectively admitting sound. A grill having relatively few cross members (such as grill 216) will be somewhat less directional than a grill having a larger number of cross members (such as grill 316). The cross section and angle of the cross members may be adjusted by changing tubes. For example, a tube having relatively large numbers of cross members, set closer together and angled sharply towards the mouth of user, may be employed when greater filtering is desired, while a tube having fewer cross members, more widely spaced cross members or cross members which do not have a cross section angled towards the mouth of the user, may be used when less filtering is desired.

During operation, the user may select and attach a microphone tube of length and shape advantageous to present conditions. For example, during a time when office noise levels are quite high, a longer tube may be used with the beveled end oriented towards the user's mouth. While the total sound energy and thus sound level transmitted to the microphone at body 100 at the user's ear is reduced, the sound transmitted is biased towards the speech of the user. On the other hand, during relatively quiet times, the same user, using the same device, might elect to remove the longer tube and go with a shorter tube, no tube at all, or a tube with a different arrangement of beveled end 212/312. The user may also make use of different grill arrangements by the same mechanism of removing one microphone tube and using another.

Not yet discussed is the aspect of the interchangeable microphone tubes of being radio antennas. It will be appreciated that microphone tubes may have an antenna within them, either in the hollow interior of the tube or in the actual wall of the tube. The microphone tube may itself be a conductive material, and in fact may take a non-tubular form such as a whip antenna shape. At the present time, it is preferred to incorporate the antenna into the microphone tube.

It will be understood that during use, the wireless headset is continuously transmitting to its base unit the sounds picked up by the microphone and is continuously receiving from it's base unit the sounds to be projected in the ear of the user by a speaker located at the unit's body. However, radio transceiving conditions change from time to time and place to place. During times when such conditions are good, no additional antenna capability may be necessary. When the conditions deteriorate, the user may desire to use a longer antenna. At such times, it is convenient to remove the microphone tube/antenna in use and replace it with another microphone tube/antenna offering better radio transceiving capability.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A wireless ear-piece headset for use with a plurality of user interchangeable microphone tubes, the ear-piece comprising:
an ear tube dimensioned and configured to be inserted into a human ear and to physically engage with the inside of the ear canal,
a body from which the ear tube projects, the body being light enough to be supported by the physical engagement of the body and ear canal, the body being a substantially compact body located at the ear of the user,
a microphone located in the body, whereby the microphone is located at the ear,
a retainer located at the microphone, the retainer dimensioned and configured to physically engage with one such user interchangeable microphone tube.

2. The ear-piece of claim 1, wherein such microphone tubes have an end hole which fits over the retainer, and the end hole has a retainer race, and the retainer has a ridge which seats into the retainer race, whereby the physical engagement of the microphone tube and the body is attained.

3. The ear-piece of claim 1, wherein such microphone tubes have an end hole which fits over the retainer, and the end hole is internally threaded, and the retainer is externally threaded, whereby the physical engagement of the microphone tube and the body is attained.

4. A wireless ear-piece headset comprising:
an ear tube dimensioned and configured to be inserted into a human ear and to physically engage with the inside of the ear canal,
a body from which the ear tube projects, the body being light enough to be supported by the physical engagement of the body and ear canal, the body being a substantially compact body located at the ear of the user,
a microphone located in the body, whereby the microphone is located at the ear,
a retainer located at the microphone, and
a plurality of rigid microphone tubes, each microphone tube dimensioned and configured to physically engage with the retainer.

5. The ear-piece of claim 4, wherein the microphone tubes may rotate when physically engaged with the retainer.

6. The ear-piece of claim 4, wherein the microphone tubes have an open end which is beveled at an angle to the longitudinal axis of the microphone tubes.

7. The ear-piece of claim 4, wherein the microphone tubes have an open end and have a grill across the open end.

8. The ear-piece of claim 4, wherein the microphone tubes each further comprise an antenna.

9. The ear-piece of claim 8, wherein the antenna is located in the interior of the microphone tube.

10. The ear-piece of claim 8, wherein the antenna is located in the microphone tube wall.

11. The ear-piece of claim 8, wherein the microphone tubes comprise a conductive material, whereby the antenna comprises the conductive material of the microphone tube.

12. A wireless ear-piece headset for use with a plurality of user interchangeable antennas, the ear-piece comprising:
an ear tube dimensioned and configured to be inserted into a human ear and to physically engage with the inside of the ear canal,
a body from which the ear tube projects, the body being light enough to be supported by the physical engagement of the body and ear canal, the body being a substantially compact body located at the ear of the user,
a microphone located in the body, whereby the microphone is located at the ear,
a retainer, the retainer dimensioned and configured to physically engage with one such user interchangeable antenna.

13. The ear-piece of claim 12, wherein such antennas have an end hole which fits over the retainer, and the end hole has a retainer race, and the retainer has a ridge which seats into the retainer race, whereby the physical engagement of the antenna and the body is attained.

14. The ear-piece of claim 13, wherein such antennas have an end hole which fits over the retainer, and the end hole is internally threaded, and the retainer is externally threaded, whereby the physical engagement of the antenna and the body is attained.
